(19) United States
(12) Patent Application Publication
(10) Pub. No.: US 2025/0088275 A1
(43) Pub. Date: Mar. 13, 2025

(54) SYSTEM FOR OPTICAL COMMUNICATION AND WEATHER MEASUREMENT

(71) Applicant: Honeywell International Inc., Charlotte, NC (US)

(72) Inventors: Matthew Wiebold, Mankato, MN (US); Alan Scott, Arnprior (CA); Andrew Csizmar, Arnprior (CA); Marc Salsbury, Gloucester (CA); Thomas Dobbins, Watertown, MN (US)

(73) Assignee: Honeywell International Inc., Charlotte, NC (US)

(21) Appl. No.: 18/799,287

(22) Filed: Aug. 9, 2024

Related U.S. Application Data
(60) Provisional application No. 63/581,929, filed on Sep. 11, 2023.

(51) Int. Cl. H04B 10/118; G01S 17/95

(52) U.S. Cl. CPC H04B 10/118; G01S 17/95

(57) ABSTRACT

A system for optical communication and weather measurement is provided. The system includes a shared telescope used to collect and focus laser beams. The optical communication system includes an optical communication transceiver and optical communication beam steering optics. The optical communication beam steering optics are configured to steer generated transmit communication laser beams to a communication satellite. The optical communication beam steering optics further are configured to steer received communication laser beams from the shared telescope to the optical communication transceiver. The weather LiDAR system includes a LiDAR laser, LiDAR beam steering optics and LiDAR weather instruments. The LiDAR laser is used to generate transmit weather laser beams. The LiDAR beam steering optics is configured to direct the generated transmit weather laser beams. The LiDAR weather instruments are configured to process scattered laser light captured by the shared telescope to determine environmental information.

### CROSS-REFERENCE TO RELATED APPLICATIONS

This application claims priority to U.S. Provisional Application Ser. No. 63/581,929 same title herewith, filed on Sep. 11, 2023, which is incorporated in its entirety herein by reference.

### BACKGROUND

Technology that has avionics applications include satellite optical communications systems and active weather light detection and ranging (LiDAR) systems. Satellite optical communication systems employ telescopes and optical-mechanical components to send and receive laser communications. Satellite optical communication systems can achieve high data rates with a reduction in power consumption and size over traditional radio frequency (RF) communications. Further, satellite optical communication systems avoid significant regulatory burdens of RF spectrum allocation while providing high carrier frequencies and narrow bandwidths. Communications through a satellite optical communication system is achieved with laser beams that are modulated with communication signals. The laser beams are precisely directed between transmit and receive terminals that are located at an associated communication satellite and ground station. Typically, the ground station includes a positioning mechanism that is used to precisely align and keep aligned transmit and receive terminals in the ground station with transmit and receive terminals in the communication satellite as the earth rotates.

A weather LiDAR system is used to measure atmospheric properties in the earth's atmosphere at high altitudes by measuring reflected or scattered back laser light from laser beams generated by a LiDAR laser of the LiDAR. The atmospheric properties may include atmospheric pressure, temperature, humidity, wind speed, wind direction, aerosol measurement, optical turbulence, gas sensing, etc. A weather LiDAR system is typically located in a ground station and includes a transmit system to transmit the laser beams into the atmosphere, a receiver system to receive reflected back laser beams, a processing system to interpret data from the transmitted and received reflected back laser beams (light), and a positioning system configured to point the weather LiDAR device to a desired portion of the atmosphere to be monitored.

### SUMMARY

The following summary is made by way of example and not by way of limitation. It is merely provided to aid the reader in understanding some of the aspects of the subject matter described. Embodiments provide an optical communication and weather LiDAR combined system.

In one embodiment a system for optical communication and weather measurement is provided. The system includes a shared telescope, an optical communication system and a weather LiDAR system. The shared telescope is used to at least collect and focus laser beams. The optical communication system includes and optical communication transceiver and optical communication beam steering optics. The optical communication transceiver includes a communication laser that is configured to generate transmit communication laser beams. The optical communication beam steering optics are configured to steer the generated transmit communication laser beams to a communication satellite. The optical communication beam steering optics further are configured to steer received communication laser beams from the shared telescope to the optical communication transceiver. The weather LiDAR system includes a LiDAR laser, LiDAR beam steering optics and LiDAR weather instruments. The LiDAR laser is used to generate transmit weather laser beams. The LiDAR beam steering optics are configured to direct the generated transmit weather laser beams. The LiDAR weather instruments are configured to process scattered laser light captured by the shared telescope to determine environmental information.

In another embodiment, another system for optical communication and weather measurement is provided. The system includes a shared telescope, an optical communication system, a weather LiDAR system, a beam splitter, an acquisition and tracking sensor, a telescope assembly housing, a controller and a memory. The shared telescope is used to at least collect and focus laser beams. The optical communication system includes an optical communication transceiver and optical communication beam spitting optics. The optical communication transceiver includes a communication laser that is configured to generate transmit communication laser beams. The optical communication beam steering optics are configured to steer the generated transmit communication laser beams to a communication satellite. The optical communication beam steering optics are further configured to steer received communication laser beams from the shared telescope to the optical communication transceiver. The weather LiDAR system includes a LiDAR laser, LiDAR beam steering optics and LiDAR weather instruments. The LiDAR laser is used to generate transmit weather laser beams. The LiDAR beam steering optics are configured to direct the generated transmit weather laser beams. The LiDAR weather instruments are configured to process scattered laser light captured by the shared telescope to determine environmental information. The beam splitter is positioned to split the received communication laser beams from the optical communication beam steering optics. The acquisition and tracking sensor is positioned to receive a portion of the received communication laser beams from the beam splitter. The telescope assembly housing contains at least the shared telescope, the optical communication beam steering optics, the LiDAR laser, and the LiDAR beam steering optics. The telescope scanning mount is configured to move the telescope assembly housing. The controller is configured to selectively position the telescope scanning mount based at least in part on acquisition and tracking information from the acquisition and tracking sensor. The memory is used to store operating instructions implemented by the controller.

In yet another embodiment, a method of operating a system for optical communication and weather measurement is provided. The method includes positioning a shared telescope for at least one of communications with a satellite and taking an atmospheric measurement; using the shared telescope when transmitting communication laser beams and receiving communication laser beams from the satellite when using an optical communication system for the communications; and using the shared telescope to capture laser light scattered off of atmospheric molecules and aerosols and focus the captured scattered laser light to LiDAR weather instruments when taking the atmospheric measurement with a weather LiDAR system.

### BRIEF DESCRIPTION OF THE DRAWINGS

The present invention can be more easily understood and further advantages and uses thereof will be more readily apparent, when considered in view of the detailed description and the following figures in which:

FIG. 1 illustrates a block diagram of an optical communication and weather LiDAR combined system according to an example aspect of the present invention;

FIG. 2 is an optical communication and weather LiDAR combined system operation flow diagram according to an example aspect of the present invention;

FIG. 3 is another optical communication and weather LiDAR combined system operation flow diagram according to an example aspect of the present invention;

FIG. 4 illustrates an adaptive optics system according to an example aspect of the present invention; and

FIG. 5 illustrates the use of two wavefront sensors according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a system for optical communication and weather measurement. In examples, a core telescope and optics of a optical communication system and a weather light detection and ranging (LiDAR) of a ground station are shared. Further in some examples, support infrastructure, such as but not limited to, a container, heating ventilation and air conditioning (HVAC), safety, and power/thermal systems are also shared. In one example, a switching system in the backend of the combined systems is used to allow either optical communications through the optical communication system or weather measurements through the weather LiDAR system. In another embodiment, the optical communications and weather measurements are done without switching between systems.

Combining hardware of the two systems (optical communication system and weather LiDAR system) provides improved system functionality with minimal replication of hardware, thus decreasing cost of a network rollout compared to two independent sets of systems, while providing both atmospheric information and communication functions. Further embodiments provide a remote command station (ground station) with access to situational awareness and high speed data communications in a compact package.

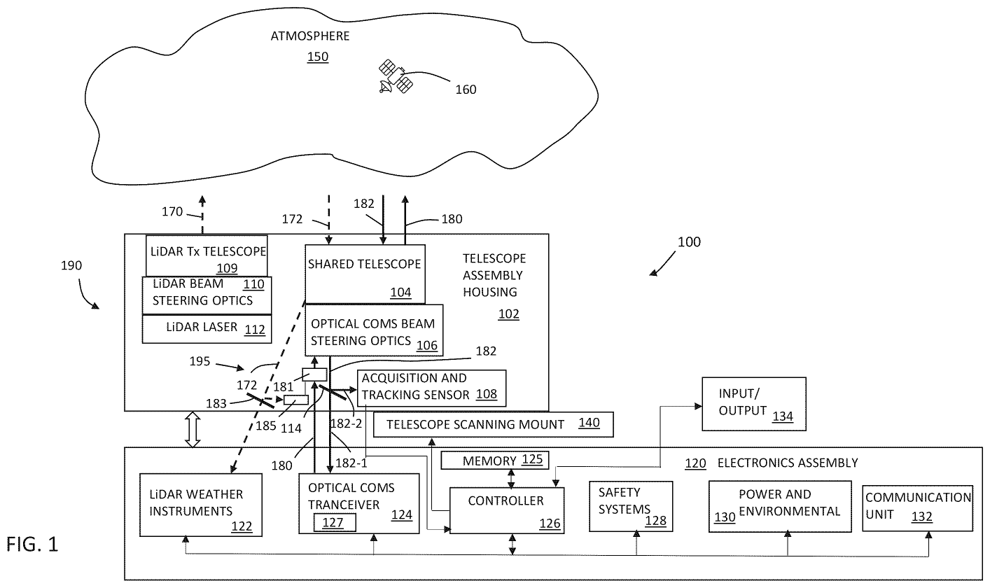

Referring to FIG. 1, system for optical communication and weather measurement 100 is illustrated. As discussed above, this system may be part of a ground station in one example. The optical communication system 195 of the system for optical communication and weather measurement 100 includes an optical communication (COMS) transceiver 124 in an electronic assembly 120 in this example. The optical communication transceiver 124 includes a communication laser 127 that is designed to generate a ground communication laser beam 180 that is modulated to include communication messages intended to be transmitted to a satellite 160. The optical communication transceiver 124 transmits the ground communication laser beam 180 to optical communication beam steering optics 106 in a telescope assembly housing 102 (container). The optical communication beam steering optics 106 may include mirrors, polarizing rotators, etc. used to direct the ground communication laser beam 180 through a shared telescope 104, that collects/captures, laser beams, focuses laser beams, and expands transmissions to the communication satellite 160. Optical communication laser beam 182 transmitted by satellite 160 are received by shared telescope 104, steered through the optical communication beam steering optics 106 to a beam splitter 114. The beam splitter 114 splits the received optical communication laser beam 182. Examples of beam splitters that may be used include, but are not limited to, a mirror beam splitter and a dichroic beamsplitter. A first portion of the optical communication laser beam 182-1 is directed to the optical communication transceiver 124 where the optical communication laser beam 182-1 is demodulated to extract a communication signal. A second portion of the optical communication laser beam 182-2 is directed to an acquisition and tracking sensor 108.

The received optical communication laser beam 182-2 from the accusation and tracking sensor 108 is used to determine needed positioning of the telescope assembly housing 102 to acquire and track the communication satellite 160 to achieve communications with the satellite 160 as the satellite moves relative to the ground station that includes the system for optical communication and weather measurement 100. In one example, a telescope scanning mount 140 is used to move (position) the telescope assembly housing 102 to track and maintain communications with satellite 160 based, at least in part, on acquisition and tracking sensor information from the acquisition and tracking sensor 108. In one example, controller 126 discussed below, based on the acquisition and tracking sensor information from the acquisition and tracking sensor 108, selectively moves the telescope scanning mount 140 to selectively position the shared telescope 104.

A controller 126 in the electronics assembly 120, based at least in part on instructions stored in a memory 125, controls the optical communication transceiver 124 in an example. In general, the controller 126 may include any one or more of a processor, microprocessor, a digital signal processor (DSP), an application specific integrated circuit (ASIC), a field program gate array (FPGA), or equivalent discrete or integrated logic circuitry. In some example embodiments, controller 126 may include multiple components, such as any combination of one or more microprocessors, one or more controllers, one or more DSPs, one or more ASICs, one or more FPGAs, as well as other discrete or integrated logic circuitry. The functions attributed to controller 126 herein may be embodied as software, firmware, hardware or any combination thereof. Controller 126 may be part of a system controller or a component controller. Memory 125 may include computer-readable operating instructions that, when executed by controller 126 provides functions of the system for optical communication and weather measurement 100. Such functions may include the functions of adjusting the position of the telescope assembly housing 102, switching between use of the optical communication system 195 and the weather LiDAR system 190, as well as other functions discussed below. The computer readable instructions may be encoded within memory 125. Memory 125 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

The weather LiDAR system 190 of the system for optical communication and weather measurement 100 includes a LiDAR laser 112 that is designed to generate transmit weather laser beams 170. Weather laser beams 170 are directed into the atmosphere 150 by LiDAR beam steering optics 110 through a LiDAR Tx telescope 109. The LiDAR beam steering optics 110 may include one or more mirrors and a beam shaping assembly in one example. Scattered laser light 172 (scattered laser beams), as the result of the photons of a weather laser beam 170 being scattered off of atmospheric molecules and aerosols, is received by the shared telescope 104 and directed to LiDAR weather instruments 122. The LiDAR weather instruments 122 of the weather LiDAR system 190 analyze the transmitted weather laser beam 170 and scattered laser light 172 to determine environmental information in the atmosphere.

Other elements that may be shared in the electronics assembly 120 of the system for optical communication and weather measurement 100 include safety systems 128, power and environmental systems 130 and a communication unit 132 in this example. The communication unit 132 may be used to communicate weather information determined by the weather LiDAR system 190 and for the communications provided by the optical communication system 195 to a remote location. The communication unit 132 may provide a cellular, WiFi, wired, etc. interface to an operator network. Further in an example, a shared input/output 134 is provided to allow for a user to input instructions to the controller 126. The input/output 134 may also include a display to display outputs of the combined system 100.

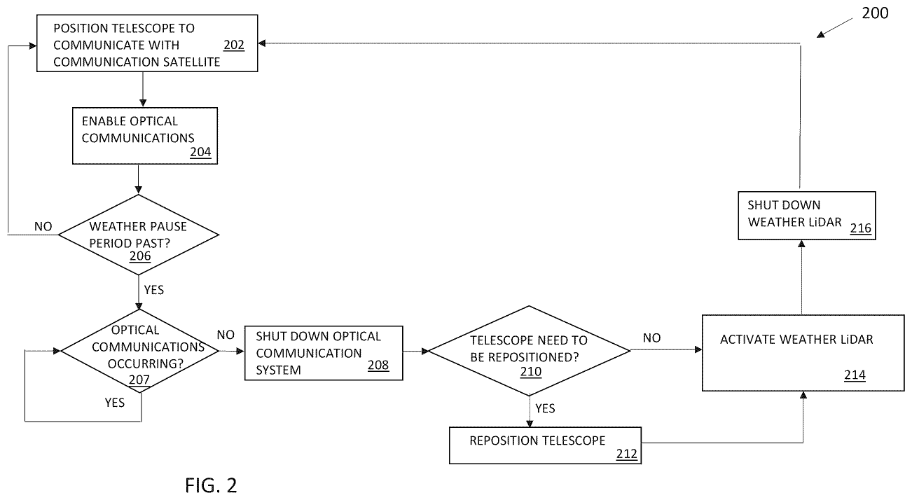

Referring to FIG. 2, a method of operating the system for optical communication and weather measurement 100 is provided in an optical communication and weather LiDAR combined system flow diagram 200. The optical communication and weather LiDAR system flow diagram 200 is provided as a series of sequential blocks that may be performed under the direction of the controller 126 implementing operating instructions stored in memory 125. The sequence, however, may be different or even in parallel in other embodiments. Hence the present invention is not limited to the sequence as set out in the optical communication and weather LiDAR system flow diagram 200.

The optical communication and weather LiDAR system flow diagram 200 starts at block 202 by positioning the shared telescope 104 of the system for optical communication and weather measurement 100 to communicate with communication satellite 160. This may be done with movement of the telescope scanning mount 140. In one example, the controller is configured to position the telescope scanning mount 140 and hence the shared telescope based at least in part on acquisition and tracking information from the acquisition and tracking sensor 108.

Once shared telescope 104 is positioned to communicate with communication satellite 160, the optical communication system 195 is enabled at block 204. This is done, in an example, by activating the optical communication system. At block 206 it is determined if a weather pause period has passed. In this example, measurements of the atmospheric environment are periodically taken. For example, measurements of the atmospheric environment may only be taken every 20 minutes or so.

If it is determined at block 206, the weather pause period has passed at block 206, it may then be determined if optical communications are then currently occurring at block 207. In this example, a measurement of the atmospheric environment is not taken until there is a break in the optical communications. Once it is determined at block 207 that there are no current optical communications taking place, in this example, the optical communication system 195 is shut down at block 208. This may, in an example, include shutting down power to at least some of the components of the optical communication system 195 at block 208 including at least some of the components in the optical communication transceiver 124. In another example, block 207 determines when communications are over for example by determining if all packets have been sent back and forth and a communication window has elapsed.

It is then determined at block 210 if the shared telescope needs to be repositioned to obtain measurements of a specific location in the atmosphere. If it is determined at block 210 that the shared telescope needs to be repositioned, the shared telescope is repositioned at block 212. Once the shared telescope is in the desired position, the weather LiDAR is activated at block 214 and atmospheric measurements are taken. Once the atmospheric measurements are taken, the weather LiDAR system 190 is shut down at block 216 and the process continues at block 202. In an example, at least some of the components of the weather LiDAR system 190 are shut down at block 216 including the LiDAR laser 112.

The example, set out in the optical communication and weather LiDAR system flow diagram 200, switches between either the optical communication system 195 or the weather LiDAR system 190. In another example, both systems may remain active during operation. In this example, wave bands used by each system are far enough apart, so the signals are easy to separate in the shared telescope 104 and direct to the desired receiver. For example, one system may use a waveband in the ultraviolet (UV) range and the other system may use a wave band in the infrared (IR) range. Further in an example, an external command from the input/output 134 or from a remote location through the communication unit 132 may be used to direct the optical communication and weather LiDAR combined system 100 to take measurements with the weather LiDAR.

The system for optical communication and weather measurement 100 may work together to provide an improved optical communication system. For example, the weather LiDAR system 190 may be used by controller 126 to gain information to enhance communications between the ground station that includes the combined system 100 and communication satellites, such as satellite 160. In this example, the weather laser beams 170 of the weather LiDAR system 190 are directed in the same direction of the transmit communication laser beam 180.

Orbiting communication satellites are moving with a transverse velocity (i.e., the transmit communication laser beam 180 needs to be pointed ahead of the angle where the received communication laser beam 182 is detected, effectively “leading” the apparent position of the satellite). Because of this angular offset between the transmit communication laser beam 180 and the received communication laser beam 182, a communication satellite beacon may not be used to measure and correct for atmospheric distortions in the transmit direction.

Controller 126 may direct the weather LiDAR to create an artificial guide star, such as a Rayleigh artificial guide star, used in the direction of the transmit communication laser beam 180 from the optical communication system 195 to correct for the atmospheric distortions instead of a communication satellite beacon. An artificial guide star is a strategy in astronomical telescopes to allow for the removal of atmospheric distortions.

Reyleigh beacons rely on the scattering of light by the molecules in the lower atmosphere. The LiDAR laser 112 may be pulsed with the measurement of the atmosphere being time-gated, taken place several microseconds after the pulse has been launched, so that scattered light at a ground level is ignored and only light that has traveled for several microseconds (i.e., reached farther up into the atmosphere and back) is detected and processed.

In an embodiment, adaptive optics 181 such as a deformable mirror or a spatial phase modulator, is positioned within the transmit path of the transmit communication laser beam 180 between the optical communication transceiver 124 and the optical communication beam steering optics 106. The adaptive optics 181 is adjusted based on the artificial guide star to pre-correct the transmit communication laser beam 180 in one example. Further in an example, a scatter laser light beam splitter 183 is used to direct a portion of the scatter laser light 172 to a wavefront sensor 185 that monitors the scatter laser light coming back from the artificial guide star created by the LiDAR laser 112 in the atmosphere.

Based on the created artificial laser guide star in the direction of the transmit communication laser beam 180, the adaptive optics 181 may be used to pre-correct the outgoing wavefront in the transmit communication laser beam 180 to significantly improve the odds of hitting an associate communication satellite 160 with the transmit communication laser beam 180.

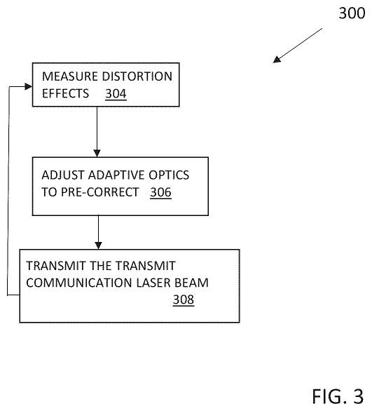

An example method of this is illustrated in an optical communication and weather LiDAR combined system operation flow diagram 300 of FIG. 3. The optical communication and weather LiDAR combined system operation flow diagram 300 is provided as a series of sequential blocks that may be performed under the direction of the controller 126 implementing operating instructions stored in memory 125. The sequence, however, may be different or even in parallel in other embodiments. Hence the present invention is not limited to the sequence as set out in the optical communication and weather LiDAR combined system operation flow diagram 300.

The distortion effects in the atmosphere 150 in the direction of a transmit optical communication laser beam are determined at block 304 by creating an artificial guide star with scattered laser light. In one example, this is done with the LiDAR weather instruments 122 analyzing the scattered laser light 172 that pass through the shared telescope. Further in an example, discussed above, a wavefront sensor 185 monitoring the scattered laser light 172 is used to generate a Rayleigh beacon guide star. The artificial guide star in the direction of a transmit optical communication laser beam is then used at block 306 to adjust the adaptive optics in the optical communication beam steering optics 106. At block 308, the transmit optical communication laser beam is then transmitted and the process continues at block 304. The transmit optical communication laser beam passes through the shared telescope 104.

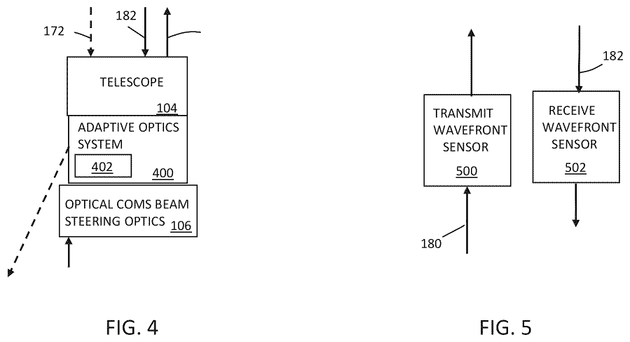

In another example that adjusts for atmospheric distortions with the system for optical communication and weather measurement 100, an adaptive optics system 400 is placed in the combined transmit and receive path between the shared telescope 104 and the optical communication beam steering optics 106 as Illustrated in FIG. 4. This example would not rely on an artificial guide star but would instead use a satellite beacon as a light source to measure the state of the atmosphere along the receive optical path. Although this example would not do as good of a job of correcting the outgoing transmitted communication laser beam (because it follows a slightly different atmospheric path leading the image of the satellite), it would improve the performance of the receiver significantly. The adaptive optics system 400 in this example would include a deformable mirror 402 behind the shared telescope 104, followed by a pick-off beam splitter 183 and a wavefront sensor 185, similar to the previous option.

Further in another example, two wavefront sensors are used. An example of this is illustrated in FIG. 5. A transmit wavefront sensor 500 is positioned in a transmit communication laser beam path of the transmit communication laser beam 180 and is configured to look at an artificial guide star directed along a point-ahead path. A receive wavefront sensor 502 is positioned in a receive communication laser beam path of the received optical communication laser beam 182 and is configured to look at the satellite beacon. Each wavefront sensor (the transmit wavefront sensor 500 and the receive wavefront sensor 502) may be used to correct the distortion along each unique optical path independently.

### EXAMPLE EMBODIMENTS

Example 1 includes a system for optical communication and weather measurement. The system includes a shared telescope, an optical communication system and a weather LiDAR system. The shared telescope is used to at least collect and focus laser beams. The optical communication system includes and optical communication transceiver and optical communication beam steering optics. The optical communication transceiver includes a communication laser that is configured to generate transmit communication laser beams. The optical communication beam steering optics are configured to steer the generated transmit communication laser beams to a communication satellite. The optical communication beam steering optics further are configured to steer received communication laser beams from the shared telescope to the optical communication transceiver. The weather LiDAR system includes a LiDAR laser, LiDAR beam steering optics and LiDAR weather instruments. The LiDAR laser is used to generate transmit weather laser beams. The LiDAR beam steering optics is configured to direct the generated transmit weather laser beams. The LiDAR weather instruments are configured to process scattered laser light captured by the shared telescope to determine environmental information.

Example 2 includes the system of Example 1, further including a beam splitter and an acquisition and tracking sensor. The beam splitter is positioned to split the received communication laser beams from the optical communication beam steering optics. The acquisition and tracking sensor is positioned to receive a portion of the received communication laser beams from the beam splitter.

Example 3 includes the system of Example 2, further including a telescope assembly housing and a telescope scanning mount. The telescope assembly housing contains at least the shared telescope, the optical communication beam steering optics, the LiDAR laser, and the LiDAR beam steering optics. The telescope scanning mount is configured to move the telescope assembly housing.

Example 4 includes the system of Example 3, further including a controller and memory. The controller is configured to selectively position the telescope scanning mount based at least in part on information from the acquisition and tracking sensor. The memory is used to store operating instructions implemented by the controller.

Example 5 includes the system of Example 4, wherein the controller is configured to selectively switch operations of the combined system between the optical communication system and the weather LiDAR system.

Example 6 includes the system of any of the Examples 4-5, wherein the controller is configured to position the telescope assembly to communicate with the communication satellite.

Example 7 includes the system of any of the Examples 1-6, further including adaptive optics system configured to adjust for atmospheric distortion.

Example 8 includes the system of Example 7, wherein the adaptive optics system is positioned in a combined transmit and receive path between the shared telescope and the optical communication beam steering optics.

Example 9 includes the system of and of the Examples 7-8, wherein the adaptive optic system includes at least one of a deformable mirror and a spatial phase modulator.

Example 10 includes the system of any of the Examples 1-9, further including support infrastructure shared between the optical communication system and the weather LiDAR.

Example 11 includes the system of Example 10, wherein the support infrastructure includes at least one of a container, a safety system, a power system, an environmental system, a communication unit and an input/output.

Example 12 includes the system of any of the Examples 1-11, further including a transmit wavefront sensor and a receive wavefront sensor. The transmit wavefront sensor is positioned in a transmit communication laser beam path. The transmit wavefront sensor is configured to look at an artificial guide star directed along a point-ahead path to correct for a distortion in the transmit communication laser beam path. The receive wavefront sensor is positioned in a receiver communication laser beam path. The receive wavefront sensor is configured to look at a satellite beacon to correct for distortion in the receiver communication laser beam path.

Example 13 includes a system for optical communication and weather measurement. The system includes a shared telescope, an optical communication system, a weather LiDAR system, a beam splitter, an acquisition and tracking sensor, a telescope assembly housing, a controller and a memory. The shared telescope is used to at least collect and focus laser beams. The optical communication system includes an optical communication transceiver and optical communication beam spitting optics. The optical communication transceiver includes a communication laser that is configured to generate transmit communication laser beams. The optical communication beam steering optics are configured to steer the generated transmit communication laser beams through the shared telescope. The optical communication beam steering optics further configured to steer received communication laser beams from the shared telescope to the optical communication transceiver. The weather LiDAR system includes a LiDAR laser, LiDAR beam steering optics and LiDAR weather instruments. The LiDAR laser is used to generate transmit weather laser beams. The LiDAR beam steering optics are configured to direct the generated transmit weather laser beams. The LiDAR weather instruments are configured to process scattered laser light captured by the shared telescope to determine environmental information. The beam splitter is positioned to split the received communication laser beams from the optical communication beam steering optics. The acquisition and tracking sensor is positioned to receive a portion of the received communication laser beams from the beam splitter. The telescope assembly housing contains at least the shared telescope, the optical communication beam steering optics, the LiDAR laser, and the LiDAR beam steering optics. The telescope scanning mount is configured to move the telescope assembly housing. The controller is configured to selectively position the telescope scanning mount based at least in part on acquisition and tracking information from the acquisition and tracking sensor. The memory is used to store operating instructions implemented by the controller.

Example 14 includes the system of Example 13, wherein information from the acquisition and tracking sensor is used to acquire and track a communication satellite.

Example 15 includes a method of operating a system for optical communication and weather measurement. The method includes positioning a shared telescope for at least one of communications with a satellite and taking an atmospheric measurement; using the shared telescope when transmitting communication laser beams and receiving communication laser beams from the satellite when using an optical communication system for the communications; and using the shared telescope to capture laser light scattered off of atmospheric molecules and aerosols and focus the captured scattered laser light to LiDAR weather instruments when taking the atmospheric measurement with a weather LiDAR system.

Example 16 includes the method of Example 15, further including shutting down at least some components of one of the optical communication system and the weather LiDAR system when another of the optical communication system and the weather LiDAR system is being used.

Example 17 includes the method of any of the Examples 15-16, further including periodically taking the atmospheric measurements.

Example 18 includes the method of any of the Examples 15-17, further including splitting the received communication laser beams so that a portion of each received optical communication laser beam is directed to an acquisition and tracking sensor; and acquiring and tracking the communication satellite based on acquisition and tracking sensor information from the acquisition and tracking sensor.

Example 19 includes the method of any of the Examples 15-18, further including creating an artificial guide star with the scattered laser light to measure distortion effects; and adjusting adaptive optics based on the artificial guide star to pre-correct the transmit communication laser beams.

Example 20 includes the method of any of the Examples 15-18, further including correcting for distortion in a transmit communication laser beam path using a transmit wavefront sensor that is configured to look at an artificial guide star directed along a point-ahead path; and correcting for distortion in a receive communication laser beam path using a receive wavefront sensor that is configured to look at a satellite beacon.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A system for optical communication and weather measurement, the system comprising:
a shared telescope to at least collect and focus laser beams;
an optical communication system including,
an optical communication transceiver including a communication laser configured to generate transmit communication laser beams, and
optical communication beam steering optics configured to steer the generated transmit communication laser beams to a communication satellite, the optical communication beam steering optics further configured to steer received communication laser beams from the shared telescope to the optical communication transceiver; and
a weather LiDAR system including,
a LiDAR laser to generate transmit weather laser beams,
LiDAR beam steering optics configured to direct the generated transmit weather laser beams, and
LiDAR weather instruments configured to process scattered laser light captured by the shared telescope to determine environmental information.

2. The system of claim 1, further comprising:
a beam splitter positioned to split the received communication laser beams from the optical communication beam steering optics; and
an acquisition and tracking sensor positioned to receive a portion of the received communication laser beams from the beam splitter.

3. The system of claim 2, further comprising:
a telescope assembly housing containing at least the shared telescope, the optical communication beam steering optics, the LiDAR laser, and the LiDAR beam steering optics; and
a telescope scanning mount configured to move the telescope assembly housing.

4. The system of claim 3, further comprising:
a controller configured to selectively position the telescope scanning mount based at least in part on information from the acquisition and tracking sensor; and
a memory to store operating instructions implemented by the controller.

5. The system of claim of claim 4, wherein the controller is configured to selectively switch operations of the system between the optical communication system and the weather LiDAR system.

6. The system of claim 4, wherein the controller is configured to position the telescope assembly housing to communicate with the communication satellite.

7. The system of claim 1, further comprising:
an adaptive optics system configured to adjust for atmospheric distortion.

8. The system of claim 7, wherein the adaptive optics system is positioned in a combined transmit and receive path between the shared telescope and the optical communication beam steering optics.

9. The system of claim 7, wherein the adaptive optic system includes at least one of a deformable mirror and a spatial phase modulator.

10. The system of claim 1, further comprising:
support infrastructure shared between the optical communication system and the weather LiDAR.

11. The system of claim 10, wherein the support infrastructure includes at least one of a container, a safety system, a power system, an environmental system, a communication unit and an input/output.

12. The system of claim 1, further comprising:
a transmit wavefront sensor positioned in a transmit communication laser beam path, the transmit wavefront sensor configured to look at an artificial guide star directed along a point-ahead path to correct for a distortion in the transmit communication laser beam path; and
a receive wavefront sensor positioned in a receiver communication laser beam path, the receive wavefront sensor configured to look at a satellite beacon to correct for distortion in the receiver communication laser beam path.

13. A system for optical communication and weather measurement, the system comprising:
a shared telescope to at least collect and focus laser beams;
an optical communication system including,
an optical communication transceiver including a communication laser configured to generate transmit communication laser beams, and
optical communication beam steering optics configured to steer the generated transmit communication laser beams through the shared telescope to a communication satellite, the optical communication beam steering optics further configured to steer received communication laser beams from the shared telescope to the optical communication transceiver;
a weather LiDAR system including,
a LiDAR laser to generate transmit weather laser beams,
LiDAR beam steering optics configured to direct the generated transmit weather laser beams, and
LiDAR weather instruments configured to process scattered laser light captured by the shared telescope to determine environmental information;
a beam splitter positioned to split the received communication laser beams from the optical communication beam steering optics;
an acquisition and tracking sensor positioned to receive a portion of the received communication laser beams from the beam splitter;
a telescope assembly housing containing at least the shared telescope, the optical communication beam steering optics, the LiDAR laser, and the LiDAR beam steering optics;
a telescope scanning mount configured to move the telescope assembly housing;
a controller configured to selectively position the telescope scanning mount based at least in part on acquisition and tracking information from the acquisition and tracking sensor; and
a memory to store operating instructions implemented by the controller.

14. The system of claim 13, wherein information from the acquisition and tracking sensor is used to acquire and track a communication satellite.

15. A method of operating a system for optical communication and weather measurement, the method comprising:
positioning a shared telescope for at least one of communications with a satellite and taking an atmospheric measurement;
using the shared telescope when transmitting communication laser beams and receiving communication laser beams from the satellite when using an optical communication system for the communications; and
using the shared telescope to capture scattered laser light scattered off of atmospheric molecules and aerosols and focus the captured scattered laser light to LiDAR weather instruments when taking the atmospheric measurement with a weather LiDAR system.

16. The method of claim 15, further comprising:
shutting down at least some components of one of the optical communication system and the weather LiDAR system when another of the optical communication system and the weather LiDAR system is being used.

17. The method of claim 15, further comprising:
periodically taking the atmospheric measurements.

18. The method of claim 15, further comprising:
splitting the received communication laser beams so that a portion of each received optical communication laser beam is directed to an acquisition and tracking sensor; and
acquiring and tracking the communication satellite based on acquisition and tracking sensor information from the acquisition and tracking sensor.

19. The method of claim 15 further comprising:
creating an artificial guide star with the scattered laser light to measure distortion effects; and
adjusting adaptive optics based on the artificial guide star to pre-correct the transmit communication laser beams.

20. The method of claim 15, further comprising:
correcting for distortion in a transmit communication laser beam path using a transmit wavefront sensor that is configured to look at an artificial guide star directed along a point-ahead path; and
correcting for distortion in a receive communication laser beam path using a receive wavefront sensor that is configured to look at a satellite beacon.
